(19) United States
(12) Patent Application Publication
(10) Pub. No.: US 2014/0297112 A1
(43) Pub. Date: Oct. 2, 2014

(54) VEHICLE SECURITY DEVICE

(71) Applicant: HOWE RENOVATION (YORKS) LIMITED, North Lincolnshire (GB)

(72) Inventor: Anthony Richard Howe, Lincolnshire (GB)

(73) Assignee: Howe Renovation (Yorks) Limited, North Lincolnshire (GB)

(21) Appl. No.: 14/236,157

(22) PCT Filed: Mar. 23, 2012
(86) PCT No.: PCT/GB2012/000267

§ 371 Date: Apr. 2, 2014

(30) Foreign Application Priority Data
May 13, 2011 (GB) 1108113.0

(51) Int. Cl. B60R 25/04

(52) U.S. Cl. CPC B60R 25/04
USPC 701/36

(57) ABSTRACT

The invention relates to a vehicle security device (10) for fitment to a vehicle (1). Device (10) has a vehicle immobiliser (11), at least one sensor (12,13,14) to sense characteristics of a driver attempting to drive a vehicle, a memory device (15) to store characteristics of one or more persons authorised to drive the vehicle, and a control device (16) to prevent unauthorised changes to the memory device. A comparator (17) compares the characteristics of the driver in the vehicle with the characteristics of persons in the memory device (15), and ensures the immobiliser (11) prevents the vehicle being driven if the characteristics of the driver attempting to drive the vehicle does not match the characteristics of one or more persons authorised to drive the vehicle.

The present invention relates to a vehicle security device.

Vehicles such as cars are often stolen by stealing the keys of a vehicle keeper and simply driving the vehicle away.

The invention seeks to avoid this problem.

According to the present invention there is provided a vehicle security device for fitment to a vehicle comprising:

a) a vehicle immobiliser,

b) at least one sensor to sense characteristics of a driver attempting to drive a vehicle,

c) a memory device to store characteristics of one or more persons authorised to drive the vehicle,

d) a control device to prevent unauthorised changes to the memory device, and

e) a comparator to compare the characteristics of the driver in the vehicle with the characteristics of persons in the memory device, and to ensure the immobiliser prevents the vehicle being driven if the characteristics of the attempting to drive the vehicle does not match the characteristics of one or more persons authorised to drive the vehicle.

Preferably the sensor senses weight and/or finger prints and/or eyes, and/or height of a person attempting to drive the vehicle.

Preferably the sensor senses characteristics of a person in a driving seat.

Preferably the control device is a keyboard operated switch which allows changes to the memory device only upon entry of a predetermined code into the keyboard. The control device may further allow the vehicle to be permanently mobilised.

An embodiment of the invention will now be described with reference to the accompanying drawings in which:

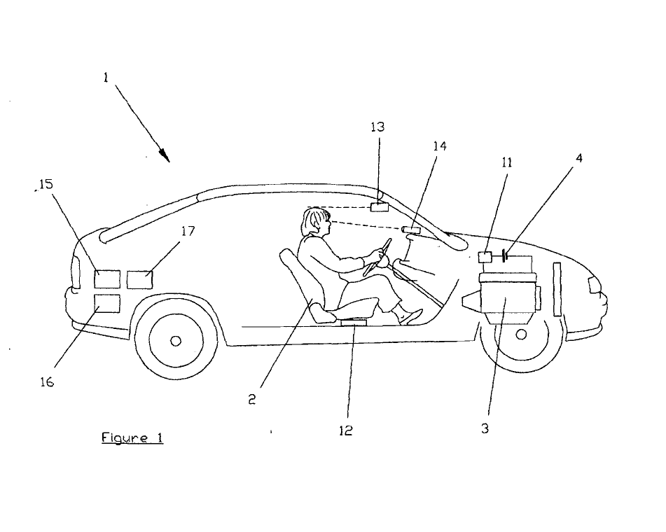

FIG. 1 show a schematic view of a vehicle fitted with the device, and

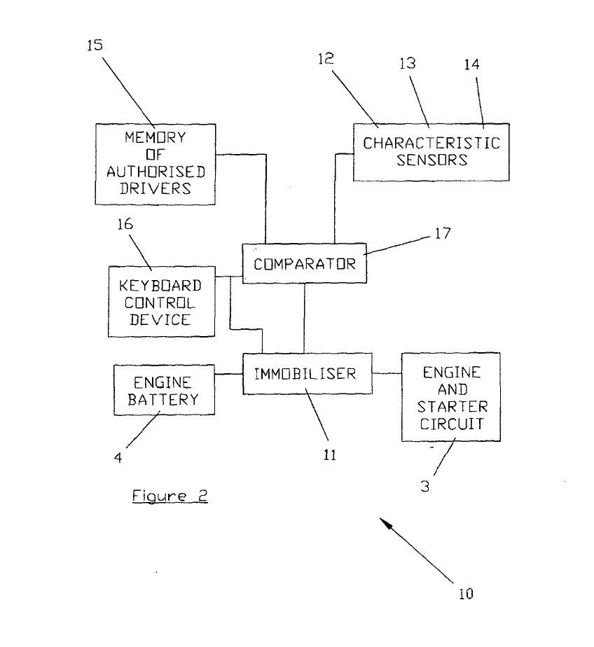

FIG. 2 shows a schematic circuit diagram.

Referring to the drawings there is shown a vehicle 1 with a seat 2, engine with starter circuit 3, battery 4 as is well known in the art.

In accordance with the present invention there is shown a vehicle security device 10 fitted to vehicle 1.

A vehicle immobiliser 11 is fitted between battery 4 and engine starter circuit 3.

At least one sensor is provided to sense characteristics of a driver attempting to drive a vehicle. Such sensor/s may be a weight device 12 under seat 2 to measure a driver's weight, may be a height sensor 13 above the dashboard measuring a drivers height, or may be a sensor on the dashboard to sense the iris pattern on an eyeball of a driver.

A memory device 15 is provided to store characteristics of one or more persons authorised to drive the vehicle. Device 15 may store the weight, height and iris or pattern of each driver authorised to drive the vehicle.

A control device having a keyboard 16 to prevent unauthorised changes to the memory device, and override the immobiliser to allow the vehicle to be permanently mobilised.

A comparator 17 compares the characteristics of the driver in the vehicle with the characteristics of persons in the memory device, and to ensure the immobiliser prevents the vehicle being driven if the characteristics of the person attempting to drive the vehicle does not match the characteristics of one or more persons authorised to drive the vehicle.

In use when a person sits on the seat 2 to drive the vehicle, the sensors will measure the weight, height and iris pattern of the driver. This is then compared with the weight, height and iris pattern of each driver authorised to drive the vehicle in memory 15. If a match exists, the driver will be allowed to start drive the vehicle using the normal key. If not the immobiliser will ensure the vehicle will not start.

It is envisaged that the code to the control device 16 might be retained by a garage. If a vehicle owner wishes to add or remove an authorised driver, the owner would take the vehicle to the garage to have any characteristics of a driver removed and would take a new authorised driver to the garage to have their weight height and iris pattern measured by the sensors 12,13,14 and stored in the memory 15. The garage can also use the control device to allow the vehicle to be permanently mobilised, e.g. so that anybody can drive the vehicle.

An advantage of having the garage controlling the control device is that it prevents a car thief from forcing the owner to divulge the code and so allow the thief's characteristics to be stored in the memory of authorised drivers.

The invention may take a form different to that specifically described. For example characteristics other than weight, height and iris pattern could be measured. Much of the electronics could be provided in a vehicle computer. A further option could include the same characteristics being stored in the two front door frames to enable the door to be unlocked without the key perhaps just by applying the door handle. Also when a person sits in the seat the ignition could start and when leaving the seat the vehicle could turn off. An override system could allow the vehicle to continue to turn over where necessary.

Further modifications will be apparent to those skilled in the art without departing from the scope of the present invention.

1. A vehicle security device for fitment to a vehicle comprising:
a) a vehicle immobiliser,
b) at least one sensor to sense characteristics of a driver attempting to drive a vehicle, wherein the at least one sensor comprises a weight sensor within the driver's seat, and/or a height sensor within the dashboard, and/or a retinal sensor within the dashboard,
c) a memory device to store characteristics of one or more persons authorised to drive the vehicle,
d) a control device to prevent unauthorised changes to the memory device, and
e) a comparator to compare the characteristics of the driver in the vehicle with the characteristics of persons in the memory device, and to ensure the immobiliser prevents the vehicle being driven if the characteristics of the driver attempting to drive the vehicle does not match the characteristics of one or more persons authorised to drive the vehicle.

2. A vehicle security device according to claim 1, wherein the sensor senses weight and/or height and/or eyeball iris pattern of a person attempting to drive the vehicle.

3. A vehicle security device according to claim 1, wherein the sensor senses characteristics of a person in a driving seat.

4. A vehicle security device according to claim 1, wherein the control device is a keyboard operated switch which allows changes to the memory device only upon entry of a predetermined code into the keyboard.

5. A vehicle security device according to claim 1, wherein the vehicle immobiliser is fitted between a battery and an engine starter circuit.

6. A vehicle security device according to claim 1, wherein the memory device is configured to store the characteristics of each driver authorised to drive the vehicle.

7. A vehicle security device according to claim 6, wherein the memory device is provided within an onboard computer of the vehicle.

8. A vehicle security device according to claim 1, wherein the control device may further allow the vehicle to be permanently mobilised.

9. (canceled)
